(19) United States
(12) Patent Application Publication
(10) Pub. No.: US 2025/0385354 A1
(43) Pub. Date: Dec. 18, 2025

(54) RECHARGEABLE BATTERY

(71) Applicant: SAMSUNG SDI CO., LTD., Yongin-Si (KR)

(72) Inventor: Kwangsoo BAE, Yongin-si (KR)

(21) Appl. No.: 19/174,547

(22) Filed: Apr. 9, 2025

(30) Foreign Application Priority Data
Jun. 13, 2024 (KR) 10-2024-0077134

(51) Int. Cl. H01M 50/176; H01M 50/15; H01M 50/533; H01M 50/553; H01M 50/636

(52) U.S. Cl. CPC H01M 50/176; H01M 50/15; H01M 50/533; H01M 50/553; H01M 50/636

(57) ABSTRACT

Disclosed is a rechargeable battery that includes: an electrode assembly having a first electrode and a second electrode; a case receiving the electrode assembly; a cap plate coupled to an opening of the case and including a terminal hole; a first electrode terminal and a second electrode terminal on the cap plate; a lead tab including a first current collecting tab for connecting the electrode assembly to the first electrode terminal and a second current collecting tab for connecting the electrode assembly to the second electrode terminal. At least one of the first electrode terminal or the second electrode terminal may include an injection hole for injecting an electrolyte into the case.

### CROSS-REFERENCE TO RELATED APPLICATION

The present application claims priority to and the benefit of Korean Patent Application No. 10-2024-0077134, filed on Jun. 13, 2024, in the Korean Intellectual Property Office, the entire disclosure of which is incorporated herein by reference.

### BACKGROUND

### 1. Field

The present disclosure relates to a rechargeable battery.

### 2. Description of the Related Art

Unlike a primary battery, a rechargeable (secondary) battery is designed to be repeatedly discharged and recharged. A small-capacity rechargeable battery is used for small, portable electronic devices, such as mobile phones, notebook computers, camcorders, and the like, while a large-capacity rechargeable battery is used as a motor-driving power source for a hybrid vehicle.

A typical rechargeable battery may include a nickel-cadmium (Ni—Cd) battery, a nickel-metal hydride (Ni-MH) battery, a lithium (Li) battery, a lithium ion (Li-ion) battery, etc. The lithium ion rechargeable battery may have an operating voltage about thrice as high as that of the Ni-Cd battery or Ni-MH battery that is generally used as a power supply for electronic devices. It may also be desirable to use the lithium ion rechargeable battery because of its energy density per unit weight which may be relatively high.

A rechargeable battery may use a lithium-based oxide as a positive active material, and a carbon material as a negative active material. Generally, batteries are classified into a liquid electrolyte battery and a polymer electrolyte battery depending on the type of electrolyte. Lithium batteries using a liquid electrolyte are generally called lithium ion batteries while batteries using a polymer electrolyte are generally called lithium polymer batteries.

An injection hole for injecting an electrolyte in a case into which an electrode assembly is received may be formed on a cap plate of the rechargeable battery.

When the injection of the electrolyte into the case is completed, a ball press-in process may be employed to seal the injection hole.

The use of the ball press-in process may add an additional complexity to the manufacturing process, making it difficult to reduce the manufacturing cost.

### SUMMARY

One or more embodiments of the present disclosure are directed to a rechargeable battery that includes an injection hole for injecting an electrolyte in an electrode terminal. Including the injection hole in the electrode terminal may help reduce manufacturing costs, when compared to a rechargeable battery includes an injection hole for injecting an electrolyte in a cap plate.

An embodiment of the present disclosure provides a rechargeable battery includes: an electrode assembly having a first electrode and a second electrode; a case receiving the electrode assembly; a cap plate coupled to an opening of the case and including a terminal hole; a first electrode terminal and a second electrode terminal on the cap plate; a lead tab including a first current collecting tab for connecting the electrode assembly to the first electrode terminal and a second current collecting tab for connecting the electrode assembly to the second electrode terminal.

At least one of the first electrode terminal or the second electrode terminal may include an injection hole for injecting an electrolyte into the case.

At least one of the first current collecting tab or the second current collecting tab may include a penetration hole connected to the injection hole.

A surface of at least one of the first electrode terminal or the second electrode terminal may include an inclined groove connected to the injection hole.

The inclined groove may include a planar surface including the injection hole and an inclined surface formed on an edge of the planar surface. The planar surface may be electrically connected to the lead tab.

The planar surface and the lead tab may be electrically connected to each

other at one or more positions by welding.

The planar surface and the lead tab may be electrically connected by one or more welded portions relative to the injection hole.

The rechargeable battery may include a welding bead for sealing the injection hole.

At least one of the first electrode terminal or the second electrode terminal may include an inclined surface at an opening of the injection hole.

An interior wall surface of the injection hole may include a guide portion for guiding the electrolyte into the case.

The guide portion may include a guide groove formed in an interior wall surface of the injection hole.

The guide groove is provided in plural and the guide grooves are arranged along a periphery of the injection hole.

According to the embodiment, the injection hole for injecting the electrolyte may be formed in the electrode terminal, and no additional electrolyte injecting opening may be formed in the cap plate. Therefore, the ball press-in process for sealing the injecting opening formed in the conventional cap plate, and parts such as a seal pin may be removed, and the manufacturing cost may be reduced.

### BRIEF DESCRIPTION OF THE DRAWINGS

FIG. 1 is a perspective view of a rechargeable battery according to an embodiment of the present disclosure.

FIG. 2 is a cross-sectional view with respect to a line II-II of FIG. 1.

FIG. 3 is a top plan view of a terminal that is installed in a cap plate of the rechargeable battery of FIG. 1.

FIG. 4 is a top plan view of an injection hole formed in a terminal according to an embodiment of the present disclosure.

FIG. 5 is a cross-sectional view of an injection hole formed in a terminal according to an embodiment of the present disclosure.

FIG. 6 is another cross-sectional view of an injection hole formed in a terminal according to an embodiment of the present disclosure.

FIG. 7 is yet another cross-sectional view of an injection hole formed in a terminal according to an embodiment of the present disclosure.

### DETAILED DESCRIPTION

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure. The drawings and description are to be regarded as illustrative in nature and not restrictive. Like reference numerals designate like elements throughout the specification.

A person of ordinary skill in the art would appreciate, in view of the present disclosure in its entirety, that a feature of embodiments of the present disclosure may be combined or combined with one or more other features, partially or entirely, and may be technically interlocked and operated in various suitable ways, and an embodiment may be implemented independently of one or more other embodiments, or in conjunction with the one or more other embodiments in a suitable manner, unless expressly stated or implied otherwise.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section.

Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

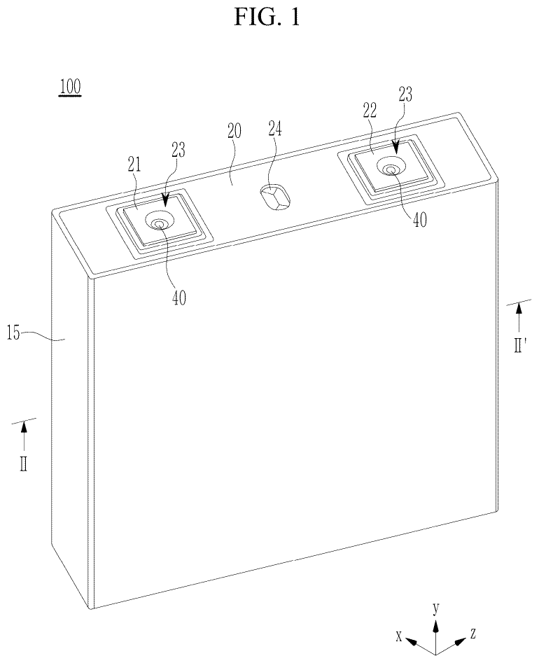

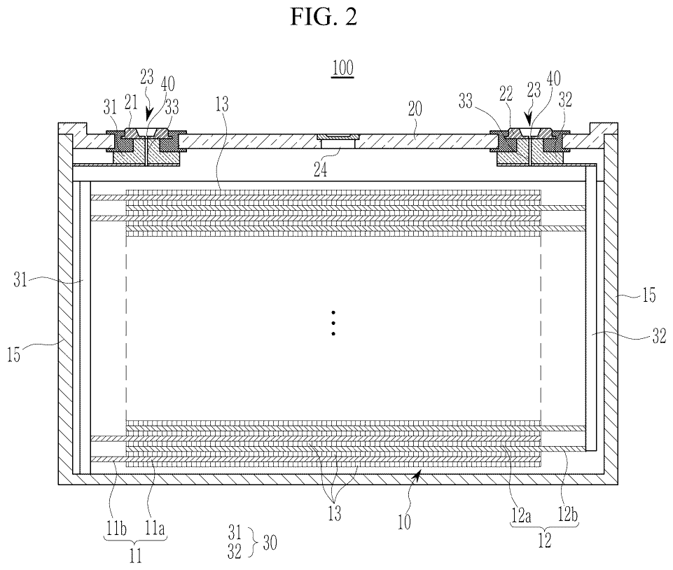

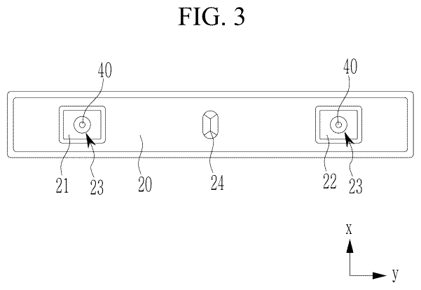

FIG. 1 is a perspective view of a rechargeable battery according to an embodiment of the present disclosure. FIG. 2 is a cross-sectional view with respect to a line II-II of FIG. 1, and FIG. 3 is a top plan view of a terminal installed in a cap plate of the rechargeable battery of FIG. 1.

As shown in FIG. 1 to FIG. 3, the rechargeable battery 100 may include: an electrode assembly 10 including a first electrode 11 and a second electrode 12, a case 15 for receiving the electrode assembly 10, a cap plate 20 combined to an opening of the case 15 and including a terminal hole, a first electrode terminal 21 and a second electrode terminal 22 on the cap plate 20, and lead tab 30 including a first current collecting tab 31 for connecting the electrode assembly 10 to the first electrode terminal 21 and a second current collecting tab 32 for connecting the electrode assembly 10 to the second electrode terminal 22, and an injection hole 40 for injecting an electrolyte into the case 15 that may be formed in one or more (e.g., each) of the first electrode terminal 21 and the second electrode terminal 22.

The electrode assembly 10 may be formed by arranging the first electrode (or a negative electrode) 11 and the second electrode (or a positive electrode) 12 on respective surfaces of a separator 13 that is an insulator, and winding the negative electrode 11, the separator 13, and the positive electrode 12 in a jellyroll state.

The negative electrode 11 and the positive electrode 12 may include coated regions 11a and 11b generated by applying an active material on a current collector of the metal plate, and uncoated regions 12a and 12b formed as an exposed current collector on which the active material is not applied.

The uncoated regions 12a and 12b of the negative electrode 11 may be formed at one end of the negative electrode 11 along the wound negative electrode 11. The uncoated regions 12a and 12b of the positive electrode 12 may be formed at one end of the positive electrode 12 along the wound positive electrode 12. In some embodiments, the uncoated regions 12a, and 12b may be arranged at respective ends of the electrode assembly 10.

In some embodiments, the case 15 is substantially formed into a rectangular parallelepiped to set a space for receiving the electrode assembly 10 and the electrolyte therein, and may form an opening for connecting an outside and the internal space on one surface of the rectangular parallelepiped. The opening may allow the electrode assembly 10 to be inserted into the case 15.

The cap plate 20 may be installed in the opening of the case 15 to seal the case 15. For example, the case 15 and the cap plate 20 may be made of aluminum and may be welded to each other.

The cap plate 20 may include a vent hole 24 and a terminal hole. The vent hole 24 may discharge an internal pressure of the rechargeable battery.

The first electrode terminal 21 and the second electrode terminal 22 may be installed on the cap plate 20 and may be electrically connected to the electrode assembly 10. The first electrode terminal 21 may be configured with a negative electrode terminal, and the second electrode terminal 22 may be configured with a positive electrode terminal. Hereinafter, the first electrode terminal and the negative electrode terminal may use the same reference numbers, and the second electrode terminal may use the same reference number as the positive electrode terminal.

In some embodiments, the negative electrode terminal 21 may pass through the terminal hole, the first end may be connected to the first current collecting tab 31, and the second end may protrude in a plate shape to the outside of the cap plate 20.

The positive electrode terminal 22 may pass through the terminal hole, the first end may be connected to the second current collecting tab 32, and the second end may protrude in a plate shape to the outside of the cap plate 20.

An injection hole 40 for injecting an electrolyte may be formed in the negative electrode terminal 21 and the positive electrode terminal 22.

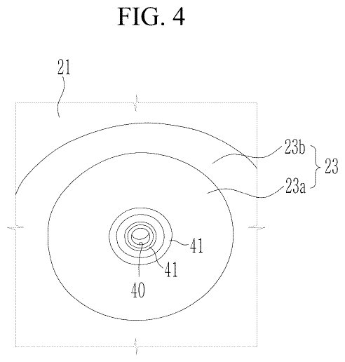

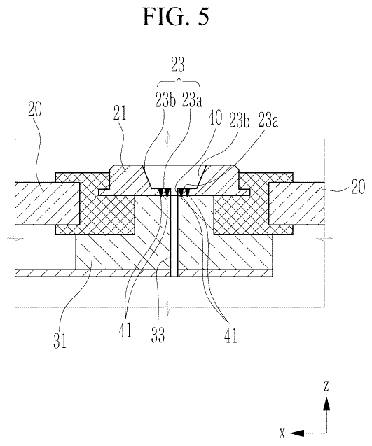

FIG. 4 is a top plan view of an injection hole formed in a terminal according to an embodiment of the present disclosure, and FIG. 5 is a cross-sectional view of an injection hole formed in a terminal according to an embodiment of the present disclosure.

As shown in FIG. 4 and FIG. 5, the injection hole 40 may be formed to penetrate the negative electrode terminal 21 and the positive electrode terminal 22, and may be formed to inject the electrolyte into the case 15.

The injection hole 40 is, for example, formed in a circular way (or to have a circular shape) to penetrate the negative electrode terminal 21 and the positive electrode terminal 22, and without being limited thereto, the injection hole may be formed in a polygonal way (or to have a polygonal shape) to penetrate the negative and positive electrode terminals.

The injection hole 40 may be formed to communicate with a penetration hole 33 formed in the first current collecting tab 31 and the second current collecting tab 32 configuring the lead tab 30 inside the case 15.

That is, the injection hole 40 with the same diameter as the penetration hole 33 may be formed in each center of the negative electrode terminal 21 and the positive electrode terminal 22, and may communicate with the penetration hole 33 formed in each of the first current collecting tab 31 and the second current collecting tab 32.

In some embodiments, the electrolyte injected through the injection hole 40 may pass through the penetration hole 33 and may be injected fluidly into the case 15.

The injection hole 40 may be used to check the attachment of one or more of the lead tab 30, the first electrode terminal 21, and the second electrode terminal 22 in addition to being used for the electrolyte injecting function.

An inclined groove 23 connected to the injection hole 40 may be formed in the cap plate 20.

The inclined groove 23 may be positioned relative to the injection hole 40 of the cap plate 20 to allow the electrolyte to be injected fluidly into the injection hole 40, and may include a planar surface 23a in which the injection hole 40 is formed, and an inclined surface 23b formed on an edge of the planar surface 23a. The inclined surface 23b may have an incline degree that is greater than 0 degrees.

The planar surface 23a may be electrically connected to the lead tab 30.

In some embodiments, the planar surface 23a may be electrically connected to the first current collecting tab 31 and the second current collecting tab 32 by welded portions 41.

The welded portion 41 may be formed on a portion of the planar surface 23a to electrically connect the planar surface 23a to the first current collecting tab 31 and the second current collecting tab 32. In some embodiments, two or more (e.g., multiple) welded portions 41 may be formed with respect to the injection hole 40 in the planar surface 23a.

In some embodiments, circular welded portions 41 with different diameters may be formed relative to the injection hole 40 of the planar surface 23a, and may electrically connect the planar surface 23a to the first current collecting tab 31 and the second current collecting tab 32. In some embodiments, the welded portions 41 may have circular shapes of one or more diameters and may be arranged along a perimeter of the injection hole 40. In some embodiments, one or more welded portions 41 may have a ring shape and be positioned to surround the injection hole 40.

The injection hole 40 may be sealed with a welding bead (e.g., a directly-connected welding bead) while the electrolyte is injected into the case 15.

As described above, the rechargeable battery 100 may form an injection hole 40 for injecting an electrolyte in the first electrode terminal 21 and the second electrode terminal 22. In some embodiments, no additional electrolyte injection opening is formed in the cap plate 20. Therefore, a ball press-in process for sealing the injection opening formed in a conventional cap plate, and parts such as a seal pin, may be removed, and the manufacturing cost may be reduced.

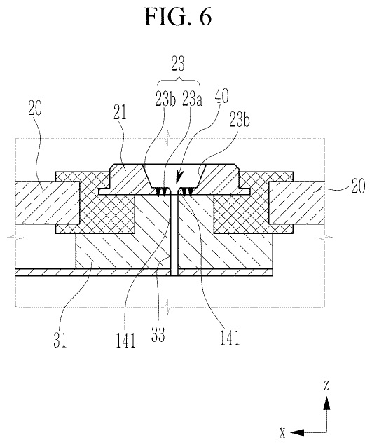

FIG. 6 is another cross-sectional view of an injection hole formed in a terminal according to an embodiment of the present disclosure. The same reference numbers as in FIG. 1 to FIG. 5 may represent the same or similar material with the same or similar functions. Accordingly, the same reference numbers will not be described in detail.

In the embodiment of FIG. 6, an inclined surface 141 may be formed in the opening of the injection hole 40 of the rechargeable battery.

In some embodiments, the inclined surface 141 formed in the opening of the injection hole conically expands in an upward direction of the first and second electrode terminals 21 and 22 to allow an injector (not shown) for injecting an electrolyte to be connected (e.g., easily connected) to the injection hole 40 to allow the fluid injection of the electrolyte.

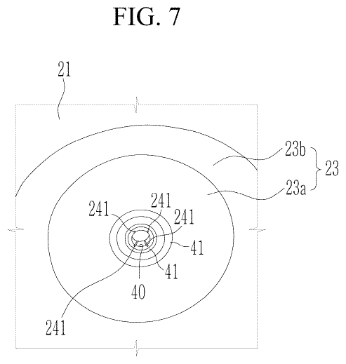

FIG. 7 is yet another cross-sectional view of an injection hole formed in a terminal according to an embodiment of the present disclosure. The same reference numbers as in FIG. 1 to FIG. 6 may represent the same or similar material with the same or similar functions. The same reference numbers will not be described in detail.

In the embodiment of FIG. 7, a guide portion 241 for guiding an injection of electrolyte may be formed on an interior wall surface of the injection hole 40 of the rechargeable battery.

The guide portion 241 may include a groove (referred to as a guide groove) formed in an interior wall surface of the injection hole 40. Hereinafter, the guide portion and the guide groove may be used interchangeably herewith, and use the same reference number.

The guide groove 241 may be formed on the interior wall surface of the injection hole 40 and extend in a length direction of the injection hole 40 to guide the electrolyte to be injected into the case.

In some embodiments, the guide groove may be provided in a plural, and the guide grooves are arranged along a periphery of the injection hole 40. Therefore, the electrolyte may be stably injected into the case 15 through the injection hole 40.

While this disclosure has been described in connection with various embodiments, it is to be understood that the disclosure is not limited to the disclosed embodiments, but it will be understood by a person of skill in the art that various modifications and equivalent arrangements may be made without departing from the spirit and scope of the appended claims and their equivalents.

### DESCRIPTION OF SYMBOLS

10 . . . electrode assembly
11 . . . first electrode, negative electrode
11a, 11b . . . coated region
12a, 12b . . . uncoated region
12 . . . second electrode, positive electrode
13 . . . separator
15 . . . case
20 . . . cap plate
21 . . . first electrode terminal
22 . . . second electrode terminal
23 . . . inclined groove
23a . . . planar surface
23b . . . inclined surface
30 . . . lead tab
31 . . . first current collecting tab
32 . . . second current collecting tab
40 . . . injection hole
41 . . . welded portion

1 what is claimed is:

1. A rechargeable battery comprising:
an electrode assembly having a first electrode and a second electrode;
a case receiving the electrode assembly;
a cap plate coupled to an opening of the case and including a terminal hole;
a first electrode terminal and a second electrode terminal on the cap plate; and
a lead tab including a first current collecting tab for connecting the electrode assembly to the first electrode terminal and a second current collecting tab for connecting the electrode assembly to the second electrode terminal,
wherein at least one of the first electrode terminal or the second electrode terminal includes an injection hole for injecting an electrolyte into the case.

2. The rechargeable battery as claimed in claim 1, wherein
at least one of the first current collecting tab or the second current collecting tab includes a penetration hole connected to the injection hole.

3. The rechargeable battery as claimed in claim 2, wherein
a surface of at least one of the first electrode terminal or the second electrode terminal includes an inclined groove connected to the injection hole.

4. The rechargeable battery as claimed in claim 3, wherein
the inclined groove includes a planar surface including the injection hole and an inclined surface formed on an edge of the planar surface, wherein the planar surface is electrically connected to the lead tab.

5. The rechargeable battery as claimed in claim 4, wherein
the planar surface and the lead tab are electrically connected to each other at one or more positions by welding.

6. The rechargeable battery as claimed in claim 5, wherein
the planar surface and the lead tab are electrically connected by one or more welded portions having a ring shape and surrounding the injection hole.

7. The rechargeable battery as claimed in claim 5 further comprising a welding bead for sealing the injection hole.

8. The rechargeable battery as claimed in claim 1, wherein at least one of the first electrode terminal or the second electrode terminal includes an inclined surface at an opening of the injection hole.

9. The rechargeable battery as claimed in claim 1, wherein
an interior wall surface of the injection hole includes a guide portion for guiding the electrolyte into the case.

10. The rechargeable battery as claimed in claim 9, wherein
the guide portion includes a guide groove formed in an interior wall surface of the injection hole.

11. The rechargeable battery as claimed in claim 10, wherein
the guide groove is provided in plural, and the guide grooves are arranged along a periphery of the injection hole.
